(19) United States
(12) Patent Application Publication
(10) Pub. No.: US 2005/0225103 A1
(43) Pub. Date: Oct. 13, 2005

(54) Pet dropping disposal device

(76) Inventor: Keiji Hatano, Ashikaga-Shi (JP)

Correspondence Address: DARBY & DARBY P.C., P. O. BOX 5257, NEW YORK, NY, 10150-5257, US

(21) Appl. No.: 11/104,241

(22) Filed: Apr. 11, 2005

(30) Foreign Application Priority Data
Apr. 13, 2004 (JP) 117681/2004

(51) Int. Cl. A01K 29/00; E01H 1/12

(52) U.S. Cl. 294/1.5

(57) ABSTRACT

The purpose of the present invention is to provide a pet owner with a pet droppings disposal device that enables to reuse various sizes of bags provided at a cash desk etc. for bringing home commodities at the time of shopping, and is also in good sanitary aspect. The gist of the present invention is that the pet droppings disposal device contains a supporting member which includes hooks for hanging grips of flexible bags having an opening on one side thereof and grips on both sides of the opening, a receiving member which is rotatably provided at a lower part of the supporting member and holds the bag with the opening of the bag kept open, and an operation means which is provided on the supporting member and operates the receiving member in the holding state of holding the bag, and in the non-holding state in which the bag is hanging from the supporting member.

### BACKGROUND OF THE INVENTION

The present invention relates to a pet droppings disposal device for disposing of pet droppings, and more particularly, to a pet droppings disposal device which enables to automatically put droppings excreted by a dog during a dog-walking into a bag without touching the droppings by hand and to easily and sanitarily dispose of the droppings.

Hitherto, in keeping a dog as a pet, everyday walk is almost necessary to eliminate its insufficient exercise. Especially, a dog owner is required to dispose of droppings excreted by a dog during a dog-walking as a manner. As general ways of disposing of droppings, such ways are adopted that after once making a dog to excrete droppings on the ground, a dog owner shovels droppings by a scooper and then puts droppings into a vinyl bag etc. to take home the bag; or that when a dog is going to excrete droppings, a dog owner places a sheet of paper or vinyl sheet on which the dog could excrete droppings, under the rear end of the dog and after excretion, wraps droppings in the sheet of paper or vinyl sheet and then, puts the wrapping into a case to take home the case.

It is undeniable, however, that such ways of disposing of dog droppings give feeling of insanitation. Thus, recently there are proposed various droppings disposal tools for cleaning up after droppings sanitarily. Taking an example of such tools, there is a tool in which a grip is formed on the rear section of the lever body of the tool and a disposable plastic bag with an upside open is detachably hung on a wheel annulation body fitted on a head. While a dog is excreting droppings, a dog owner places the lever body under the rear end of the dog by hand, and thereby can receive the droppings inside the plastic bag. In this case, a dog owner can receive and throw out the droppings without touching the droppings. Therefore, it is also in good sanitary aspect (see Publication of Unexamined Japanese Patent Application No. 2004-16217).

On the other hand, when a shopper brings home commodities after shopping, the commodities are put into various-sizes of bags according to the quantity of commodities at the cash desk.

Thereafter, the commodities are taken out after being brought home. As for a conventional pet droppings disposal device, a disposable plastic bag with an upside open is detachably hung on a wheel annulation body, however, the disposable plastic bag is merely hung down on the wheel annulation body. Thus, if a dog moves, a dog owner should displace the lever body by hand according to the movement of the dog, or the plastic bag is liable to drop out of the wheel annulation body, if the wind blows.

Furthermore, the provided various sizes of bags in which commodities are put at the cash desk at the time of bringing home commodities in shopping are thrown away after the commodities are taken out.

### SUMMARY OF THE INVENTION

The present invention has been made to resolve such problems of the prior art, and intends to provide a pet droppings disposal device which enables to reuse various sizes of bags provided at the cash desk when a shopper brings home commodities in shopping, and is also in good sanitary aspect.

That is to say, the pet droppings disposal device according to the present invention contains a supporting member on which hooks are provided for supporting the grips of flexible bags having an opening on one side thereof and grips on both sides of the opening concerned; a receiving member rotatably provided at a lower part of the supporting member to hold the bag with the opening of the bag kept open; and an operation means which is provided on the supporting member and operates the receiving member in the holding state of holding the bag or non-holding state in which the bag is kept hanging from the supporting member.

Thus, according to the present invention, a pet owner can put droppings of pets in a bag hanging from the supporting member, if a pet owner receives, for example, droppings of a pet in the opening of a bag in the holding state and puts the bag into the non-holding state by operating the operation member. Thus, since a pet owner can put droppings of pets into a bag without soiling hands, it enables a pet owner to dispose of droppings of pets very sanitarily.

Further, in the pet droppings disposal device according to the present invention, as mentioned above, the operation means is disjunctively provided on the receiving member and contains an arm touching with a receiving member to keep the receiving member in a holding state and a bias member for biasing the arm toward the receiving member.

According to the present invention, in addition to the foregoing, a pet owner can easily separate the arm from the receiving member against the bias force of the bias member by only operating the arm to move toward the direction, separating from the receiving member side. Thus, since a pet owner can easily change the receiving member from the holding state of holding the bag to the non-holding state in which the bag hangs from the supporting member, for example, a pet owner can easily put droppings of pets in the opening of a bag hanging from the supporting member. Accordingly, it enables a pet owner to put droppings of pets into a bag very sanitarily.

Furthermore, in addition to the above-mentioned inventions, the pet droppings disposal device according to the present invention is characterized by providing a bag-retention for holding the opening of a bag kept open on the receiving member.

According to the present invention, in addition to each invention mentioned above, since in the holding state of the receiving member holding the bag when the pet droppings disposal device is used, the overall thickness of the bag can be reduced with the opening of the bag kept open by the bag-retentions. Accordingly, for example, it enables a pet owner to easily place the receiving member under the rear end of a dog and to securely hold the droppings in the opening. Thus, even in the state of displacing the bag toward the direction that the dog moves or in the wind blowing, it enables to hold the plastic bag on the receiving member with the opening of the bag kept open. Accordingly, since the bag placed on the receiving member does not move, it enables to securely catch the pet droppings in the opening of the bag.

Further, the pet droppings disposal device of the present invention is characterized by providing multiple-tiered hooks in each invention mentioned above.

According to the present invention, in addition to each invention mentioned above, for example, grips of various sizes of bags can be hung on any of multiple-tiered hooks. Particularly, if a pet owner fits the positions of hooks placed in each tier to the various sizes of bags provided at the cash desk at the time of bringing back the commodities in shopping. Thus, it enables to effectively use all of those various sizes of bags. Accordingly, it will enable to greatly enhance the convenience of the pet droppings disposal device.

### BRIEF DESCRIPTION OF THE DRAWINGS

FIG. 1 is a front view of a pet droppings disposal device, showing an embodiment of the present invention.

FIG. 2 is a side view of the pet droppings disposal device shown in FIG. 1.

FIG. 3 is a plain view of the pet droppings disposal device shown in FIG. 1.

FIG. 4 is a front view of a bag used for the pet droppings disposal device of the present invention.

FIG. 5 is a diagram showing the holding state of a receiving member wherein an arm abuts on a lock claw.

FIG. 6 is a diagram showing a non-holding state that the receiving member hangs from a supporting member with the arm released from the lock claw.

FIG. 7 is a side view of the pet droppings disposal device showing a state that the grips of a bag hang on a hook.

FIG. 8 is a plain view of the pet droppings disposal device showing that an open bag is retained at the opening by bag-retentions provided on the receiving member.

FIG. 9 is a side view of the pet droppings disposal device showing the state in which droppings are being caught in an open bag.

FIG. 10 is a side view of the pet droppings disposal device showing the non-holding state of the receiving member which hangs a bag containing droppings from the supporting member.

### DETAILED DESCRIPTION OF THE PREFERRED EMBODIMENTS

The present invention is characterized in that the invention prevents feeling of insanitation at the time of disposing of dog droppings, and enables to fully utilize the various sizes of bags provided at the cash desk at the time of bringing home the commodities in shopping. Namely, the purposes for preventing feeling of insanitation and utilizing the various sizes of bags provided at the time of bringing home the commodities in shopping have been achieved by providing multiple-tiered hooks for hanging grips of bags on a supporting member and a receiving member for holding the bag at a lower part of the supporting member.

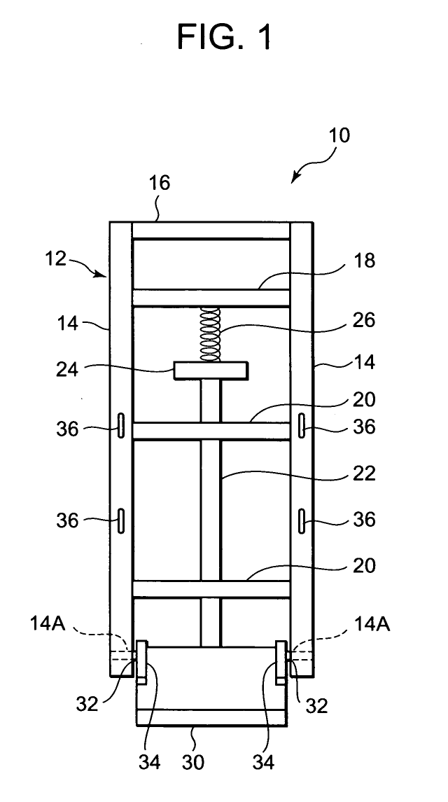

Next, based on the drawings, the embodiments of the present invention will be described. As shown in FIG. 1, a pet droppings disposal device 10 contains a supporting member 12 and a receiving member 30 that is provided to be movable at a lower part of the supporting member 12. The supporting member 12 contains a pair of longitudinal supporting bars 14 placed at a fixed interval, a handle 16 which is provided at the top end of both supporting bars 14 and enables to carry the pet droppings disposal device 10, and a grip member 18 and transverse supporting bars 20 provided across longitudinal supporting bars 14 on both sides. The receiving member 30 will be described in detail later.

The relevant pet droppings disposal device 10 is composed of a portable size, for example, about 300-500 mm in length and about 150-200 mm in width. Namely, the longitudinal supporting bars 14, the handle 16, the grip member 18 and the transverse supporting bars 20 are each composed of angle casings (a cylindrical casings may also be available in this case) about 15-30 mm on a side and these angle casings are composed of aluminum or plastics etc. The longitudinal supporting bar 14 is about 300-500 mm in length; the handle 16, grip member 18 and transverse supporting bar 20 are each 150-200 mm in length.

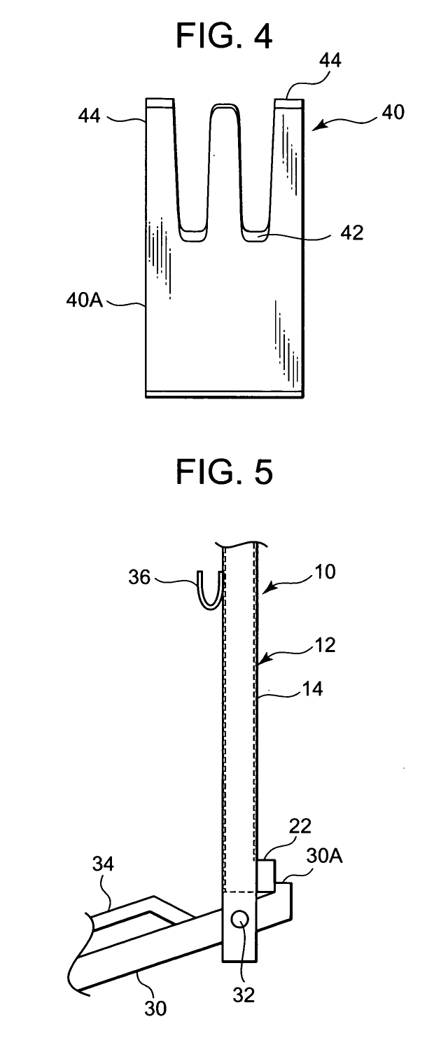

On the longitudinal supporting bars 14 on both sides, a plurality of hooks 36 for hanging the grips 44 of a bag 40 (shown in FIG. 4), described below are provided. These hooks 36 are in the shape of a rod about 5 mm in diameter, and are formed in the shape of U-like letter in sides. And the one side is fixed on the longitudinal supporting bar 14 and the upper side (facing the grip member 18) is open. The hooks 36 are provided on a parallel with the longitudinal supporting bars 14 on both sides, facing each other, and multiple-tiered hooks are provided toward the horizontal and vertical directions (double-deck in the embodiment) Further, the number of tiers of the hook 36 to be provided toward the horizontal and vertical directions is not limited to double-tiers, but many tiers such as three, four, five and six in conformity with the sizes of bags 40 to be used.

Namely, multiple-tiered hooks 36 are provided between the receiving member 30 and grip member 18. These hooks are provided integral with the longitudinal supporting bar 14. Further, the hook 36 may be formed from a metal (wire) as a separate body and screwed to the longitudinal supporting bar 14. In this case, it is convenient to enable to prevent the hook 36 from breaking, since the hook can elastically deforms, even if it somewhat deforms. Moreover, as will be mentioned below, since there are different sizes of bags 40, large bags are hung from upper hooks of multiple-tiered hooks 36 provided on the supporting member 12 and small bags are hung from the lower supporting member 12, respectively.

The grip member 18 provided across the longitudinal supporting bars 14 on both sides is provided on the side of the receiving member 30, placing apart from the handle 16 by a fixed distance. The transverse supporting bars 20 are provided between the handle 16 and the receiving member 30, placing a fixed distance. These handle 16, grip member 18, and transverse supporting bars 20 are fixed to the longitudinal supporting bars 14 on both sides with screws or welding, as not illustrated.

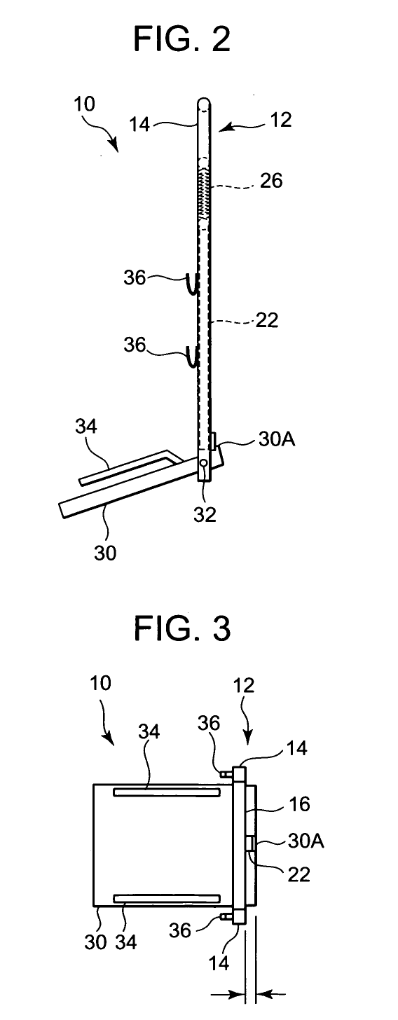

The receiving member 30 is formed in a longitudinal rectangle-like plate which is about 150-200 mm in length and about 130-180 mm in width. At the bottom of longitudinal supporting bars 14 on both sides, there is provided a through hole 14A through which a rotary shaft 32 can be inserted on the receiving member 32 as shown in FIG. 2, and there is Fixed dimension extending rotary shafts 32 are provided in both ends of one side of the longitudinal directions in the receiving member 30. And, the receiving member 30 extends forward of the supporting bars on both sides in the state the shafts 32 is inserted into the through holes 14A of the bottom of the receiving member 30 and also extents rearward of a fixed distance.

Namely, as shown is FIG. 3, the most part of the receiving member 30 extends forward of the supporting member 12, and also extends rearward by about 15-30 mm in this case (within the range as shown by facing arrows). A lock claw 30A (shown in FIG. 5) that touches with an arm 22, described below, is provided in the portion of the receiving member 30 that extends rearward of a fixed distance from the supporting member 12. The receiving member 30 that is about 3 mm in thickness, is formed in a wave shape like a corrugated-tin-plate, and is constituted so as not to easily deform.

Now, a bag 40 will be described. The bag 40 is a bag which is provided, putting commodities inside like food, at the cash desk when a shopper shops such commodities and is going to bring home commodities. As for this bag 40, both a big one and a small one are used depending on the quantity of purchased commodities. The pet droppings disposal device 10 of the present invention is constituted so as to be able to use both big bags and small bags, as mentioned above. The relevant bag 40 is a semitransparent, white or colored bag 40 for bringing back commodities, and is flexible. As shown in FIG. 4, the bag 40 is a general bag for bringing back commodities at the bottom of which a bag body 40A for putting in commodities is provided and at the upper portion of which an opening 40 is formed, and grips 44 are provided on both sides of the opening 42.

Pair of bag-retentions 34, in the shape of a rod in about 5 mm diameter, are provided integral with the receiving member 30. The bag-retentions 34 extend forward of the side of the supporting member 12 by a fixed distance (in this case, the bag-retentions 34 extend to a point near the front end of the receiving member 30), and are provided on both sides of the receiving member 30. The one side of the bag-retention 34 is fixed on a place near the supporting member 12 of the receiving member 30, and the front side of the bag-retention 34 is apart from the receiving member by a fixed distance so that the bag 40 can be inserted through an opening formed at the front end of the bag-retention 34. Further, the bag-retentions 34 may be formed from an elastic metal (wire) as a separate body from the receiving member 30 so that the bag-retentions 34 are screwed to the receiving member 30 at a place near the supporting member 12. In this case, even if being somewhat deformed, the bag-retention 34 can conveniently be prevented from being damaged since the deformation is merely elastic.

On the other hand, an operation means is provided on the supporting member 12. The operation means is constituted, with the opening 42 of the bag 40 being kept open, so as to enable to operate the bag 40, in the holding state of the receiving member on which the bag 40 is held and to operate the bag 40 in the non-holding state of the supporting member 12 from which the bag 40 is hung from the supporting member 12. The operation means is composed of an arm 22 and a bias member 26. The arm 22 which is inserted in a through hole (not being illustrated) provided around the central part of the lateral supporting bar 20 is formed to be movable up and down, and at the same time to be disjunctive from the receiving member 30.

The bias member 26 is constituted of, for example, a coil spring and is provided between the upper end of the arm 22 and the grip member 18. The bias member 26 is comprised so as to always bias the arm 22 to the side of the receiving member 30, in this state. Further, the bias member 26 is fixed to the grip member 18 and the arm 22 with screws (not being illustrated) and formed so as not to fall off.

The operation member 24 is provided at the upper end of the arm 22, and is provided almost parallel to the grip member 18. The operation member 24 is composed of a cylinder which is about 15-20 mm in diameter and about 100-150 mm in length. The lower end of the arm 22 that is biased by the bias member 26 touches with the lock claw 30A that is provided by being extended by the fixed distance behind the receiving member. In this state the receiving member 30 inclines the front side of the supporting member 12 downward by about 15-20 degrees.

Further, as shown in FIG. 5, in the state that the lock claw 30A touches with the arm 22, the lock claw 30A touches with the side of the arm 22. Namely, the lock claw 30A of the receiving member 30 is composed so that a stress can work in a direction of about right angles to the to the vertical shock direction of arm 22. The lock claw 30A touches with the side of the arm 22 like mentioned above. Therefore, even if the bias force of the bias member 26 is reduced, it is possible to hold the receiving member 30 almost in a horizontal position without rotating downward upon the shaft 32. In this case, the bias member 26 depresses the bias force thereof so long as the disposal and user-friendliness of the pet droppings disposal device 10 are not harmed.

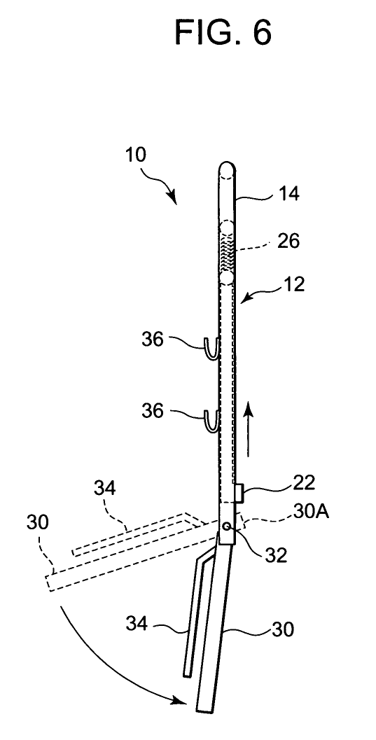

As shown in FIG. 6, if the operation member 24 is moved toward the grip member 18 (the direction pointed by arrow in FIG. 6) the receiving member 30 rotates downward upon the shaft 32 by its own weight. And, if the operational member 24 and grip member 18 are held by hands, and the operational member 24 is moved to the side of the grip member 18, or if the operational member 24 is moved to the side of the grip member 18 by hands, the receiving member 30 is composed to hang down by its weight (in the drawing, the state of the receiving member 30 is changed from the state of dotted lines to the state of solid lines).

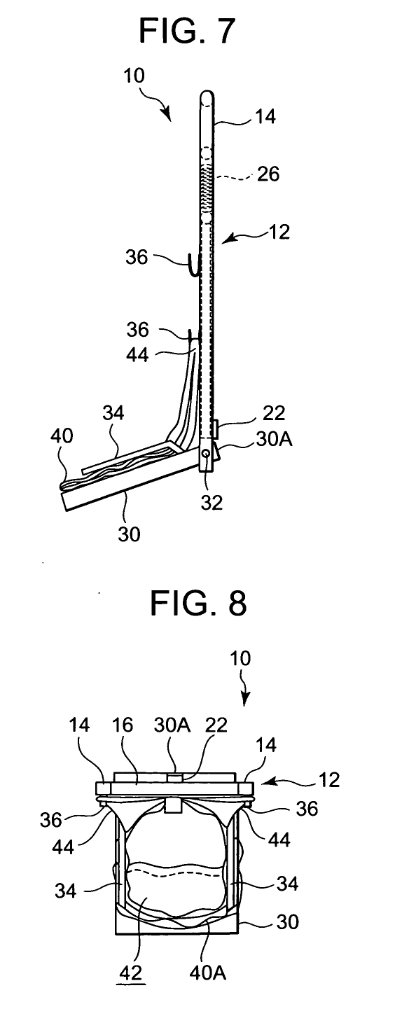

Now, in accordance with the constitution, the usage of the pet droppings disposal device 10 will be described in reference to FIG. 7. Here, a small bag 40 is used. Further, it is assumed that the lock claw 30A provided at the rear side of the receiving member 30 touches with the lower end of the arm 22, and that the receiving member 30 is in the holding state of enabling to hold the bag 40 on the upper surface thereof. And one of the grips 44 of the bag 40 is hung from the hook 36 provided on one of the longitudinal supporting members 14 and the other grip 44 is hung from the hook 36 provided on the other longitudinal supporting member 14.

Next, as shown in FIG. 8, opening the opening 42 of the bag on the whole of the top surface, the both ends of the opening 42 are pinched in between the receiving member 30 and the bag-retention 34. Thereby both sides of the opening 42 are pressed to the receiving member 30 by the bag-retentions 34 and the bag 40 is held in the state of being open. At this time, if a pet owner hooks the opening 42 of the bag 40 on the top end of the bag-retention 34, a pet owner can keep the opening 42 of the bag 40 more certainly open.

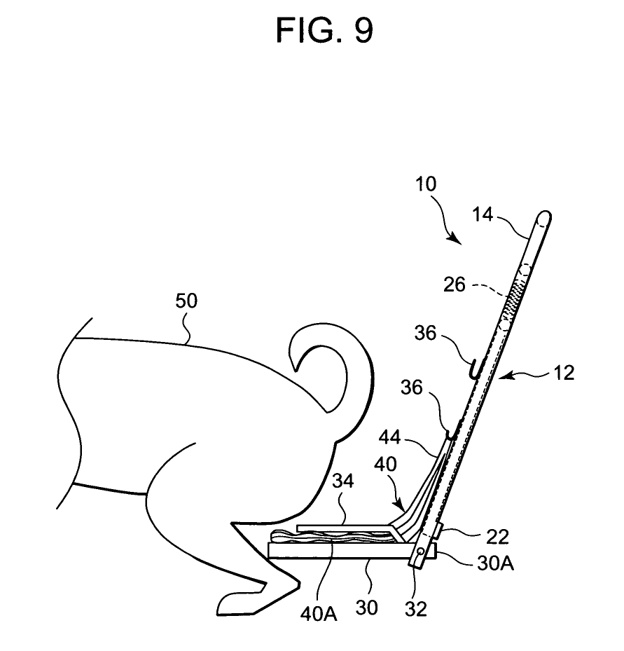

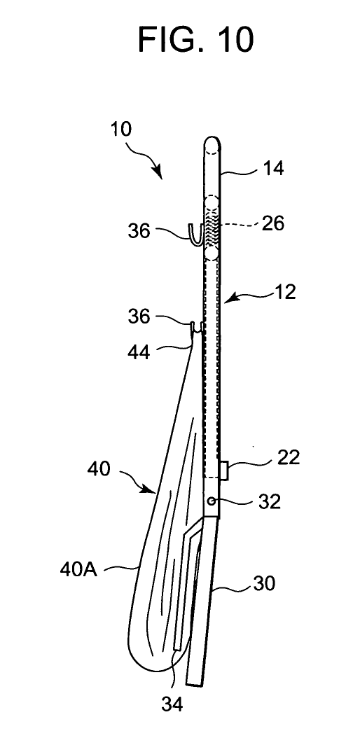

And, if evacuation begins during the walk of the dog 50 (corresponding to the pets of the present invention), as shown in FIG. 9, the owner inserts the receiving member 30 under the rear side of the dog 50, while keeping the receiving member in an about horizontal position. At this time, since the bag 40 is pressed by the bag-retentions 34, a pet owner can certainly place the opening 42 of the bag 40 under the rear side of the dog 50 without the bag 40 transferring or moving due to the wind. Thereby, a pet owner can certainly catch the droppings of the dog 50 within the opening 42 of the bag 40. Further, since the receiving member 30 is inclined downward by about 15-20 degrees in the front side of the supporting member 12, a pet owner can separate the handle 16 from the dog 50, while the receiving member 30 is kept in a horizontal position. Thus, it is very convenient to be able to securely catch the droppings in the opening 42 of the bag 40 by locating the receiving member 30 just under the rear side of the dog 50 while being kept separated from the dog 50.

After a dog 50 finishes evacuating droppings, a dog owner grips an operation member 24 and a grip member 18 by hand and displaces the operation member 24 to the side of the grip member 18. If the operation member 24 is gripped, the bias member 26 is depressed and the arm 22 moves toward the side of the grip member 18. Thereby, the lock claw 30A that touches with the arm 22 behind the receiving member 30 deviates and the receiving member 30 which is in the holding state of the bag 40 rotates downward by its weight supported by the rotary axis. As a result, the bag 40 gets to the non-holding state in which the hangers 44 are hang from the hooks 36 provided on the supporting member 12, and the bag 40 is hung.

If the receiving 30 gets to the non-holding state in which the grips 44 of the bag 40 are hung from the hooks 36, the bag body 40A containing the droppings falls down in compliance with that. At this time, since grips 44 on both sides of the bag 40 are hung from the hooks 36 provided on supporting members 12 on both sides, therefore, only the bag body 40A including droppers falls down and the bag 40 hangs from the hooks 36. Then, a dog owner removes grips 44 on both sides from the hooks 36, and bounds to shut the opening 42 of the bag 40. Thereby, a dog owner can put the droppings excreted by the dog 50 in the bag 40 and dispose of the droppings without touching the droppings.

Thus, the pet droppings disposal device of the present invention includes a supporting member 12 which includes hooks 36 hanging handles 44 of flexible bags 40 which include an opening 42 on one side thereof and handles 44 on both sides of the opening 42, a receiving member 30 which is rotatably provided at a lower part of the supporting member 12 and holds the bag 40 with the opening 42 of the bag 40 kept open, and an operation means which is provided on the supporting member 12 and operates the receiving member 30 in the holding state of the receiving member 30 holding the bag on the upper surface of the receiving member 30 and in the non-holding state of the receiving member 30 in which the bag 40 hangs from the supporting member 12.

Therefore, if a dog owner puts the bag to the non-holding state by operating the operation means, after catching the droppings of the dog 50 in the opening 42 of the bag 40 in the holding state, a dog owner can put the droppings in the bag 40 hanging from the supporting member 12. Thereby, a dog owner can put the droppings of the dog in the bag 40 without soiling his/her hands and thus, it enables a dog owner to dispose of the droppings of the dog very sanitarily.

Further, the operation means is disjunctively provided on the receiving member 30, and contains the arm 22 that touches with the receiving member 30 and holds the receiving member 30 in the holding state, and the bias member 26 that biases the arm 22 to the direction of the receiving member 30. Thus, a dog owner can easily remove the arm 22 from the receiving member 30 by only operating the arm 22 so as to replace to the direction separating from the receiving member 30, as against the bias force of the bias member 26. Thereby, since a dog owner can put the bag 40 from the holding state of receiving member 30 holding the bag 40 on the upper surface thereof to the non-holding state of the receiving member 30 wherein the bag 40 is not held on the upper surface thereof but is directly hung from the hooks 36 provided on the supporting member 12. Therefore, a dog owner can easily put the droppings caught in the opening 42 of the bag 40 in the bag 40 hanging from the supporting member 12.

Also, the receiving member 30 is provided with the bag-retention 34 holding the opening 42 of the bag 40 kept open. Therefore, under the holding state of the receiving member holding the bag 40 at the time of using a pet droppings disposal device 10, the overall thickness of the bag can be reduced with the opening 42 of the bag 40 kept open by the bag-retentions. Therefore, a dog owner can easily insert the bas under the rear side of the dog 50, and can securely hold the droppings in the opening 42 of the bag 40. Further, as the bag 40 is retained by the bag retention members 34, the bag 40 placed on the receiving member 30 never moves. Thereby, even in the state of displacing the bag toward the direction that the dog moves or in the wind blowing, it enables to hold the bag on the receiving member with the opening of the bag kept open it enables a dog owner to catch certainly the droppings of the dog 50 within the opening 42.

Further, since multiple-tiered hooks 36 provided on the supporting member in an up-and-down direction, the grips 44 of a large bag are hung from the hooks 36 on the upper hook of the multiple-tiered hooks 36 provided, and the grips 44 of a small bag are hung from the hooks 36 on the lower tier of multiple-tiered hooks provided. Thereby, since various sizes of bags 40 provided at the cash desk at the time of bringing home commodities in shopping can be hung from any of the multiple-tiered hooks 36 provided, a dog owner can reuse such various sizes of bags. Consequently, it enables to laconically and effectively use various sizes of bags 40 provided at the cash desk at the time of bringing home commodities in shopping, and upgrade the convenience of the pet droppings disposal device to a large extent.

Further, in the embodiments, there is provided a description of the dimensions and materials of the pet droppings disposal device 10, however, those dimensions and materials of the pet droppings disposal device 10 are not limited thereto, if the pet droppings disposal device 10 can easily be carried without being damaged.

Further, the bias member 26 is provided between the top end of the arm 22 and the grip member 18, however, the bias member 26 can be given such configuration wherein a coil spring (not illustrated) is provided between the arm 22 and the transverse supporting member 20 and the arm 22 is biased toward the receiving member 30. In this case, when a pet owner grips the operation member 24 and the grip member 18 by hands, the coil spring does not get in the way of operation. Therefore, it is good in operationality and convenient to be operated.

1. A pet droppings disposal device comprising:
a supporting member which provides hooks hanging the handles of flexible bags which include an opening on one side thereof and handles on both sides of the opening;
a receiving member which is rotatably provided at a lower part of the supporting member and holds the bag with the opening of the bag kept open, and
an operation means which is provided on the supporting member and operates the receiving member in the holding state of holding the bag and in the non-holding state of the bag hanging from the receiving member.

2. A pet droppings disposal device according to claim 1, which is disjunctively provided on the receiving member, comprising:
an arm which touches with the receiving member and keeps the receiving member in the holding state, and
a bias member which biases the arm to the direction of the receiving member.

3. A pet droppings disposal device according to claim 1, which provides a bag-retention for holding the bag with the opening kept open on the receiving member.

4. A pet droppings disposal device according to claim 1, which provides the multiple-tiered hooks on the supporting member.

5. A pet droppings disposal device according to claim 2, which provides a bag-retention for holding the bag with the opening kept open on the receiving member.

6. A pet droppings disposal device according to claim 2, which provides the multiple-tiered hooks on the supporting member.

7. A pet droppings disposal device according to claim 3, which provides the multiple-tiered hooks on the supporting member.
